(19) United States
(12) Patent Application Publication
(10) Pub. No.: US 2007/0199899 A1
(43) Pub. Date: Aug. 30, 2007

(54) Sweep-flow methods and clogging disrupters, for expanded bed chromatography of liquids with suspended particulates

(76) Inventor: Andrew Alaska, North Branford, CT (US)

Correspondence Address: Patrick D. Kelly, 11939 Manchester #403, St. Louis, MO, 63131, US

(21) Appl. No.: 11/097,537

(22) Filed: Mar. 31, 2005

Related U.S. Application Data
(60) Provisional application No. 60/558,259, filed on Mar. 31, 2004.

(51) Int. Cl. B01D 15/08

(52) U.S. Cl. 210/659; 210/656; 435/7.1

(57) ABSTRACT

Devices for expanded bed chromatography use inlet and outlet ports beneath a mesh that supports sorbent beads in a column. Placement of both ports beneath the mesh provides a horizontal “sweep flow” tangential to the mesh, to suppress the formation of particulate cakes on the lower surface of the mesh when liquids containing high particulate loads (such as cells or cell debris) are being processed. This design can be used with vibrators, hammering devices, intermittent reverse flow, or other means for disrupting the formation of particulate cakes or aggregates. Disrupters can also be used during elution, to accelerate the release of the valuable molecules from the sorbent. Initial tests indicate that these systems can efficiently handle heavily loaded liquids that would rapidly clog other systems previously known in the art.

### RELATED APPLICATION

The Applicant claims the benefit under 35 USC 119(e) of provisional application 60/558,259, filed on Mar. 31, 2004.

### FIELD OF THE INVENTION

This invention relates to biochemistry and purification, and to methods and devices for “expanded bed” chromatography of liquids that contain particulates such as cells or cell debris.

### BACKGROUND OF THE INVENTION

As used herein, “chromatography” refers to any purification process in which a liquid solution containing one or more types of valuable molecules is passed through a device, referred to herein as a column, that contains a controlled and selected type of reagent or other material (referred to herein as a “sorbent” material) that can be used to purify or at least concentrate the desired and valuable molecules (for convenience, the molecules being purified are referred to herein as “target” molecules).

As an example that is illustrative rather than limiting, the target molecules that need to be purified may be proteins having a known amino acid sequence (such as a hormone or growth factor, or any other diagnostic or therapeutic protein), and the sorbent material in the column may comprise antibodies that will bind to the desired protein, affixed to the surfaces of tiny beads made of silica, polymers, agarose, etc. The beads typically have diameters in a range of about 3 to 300 microns. This allows the beads (with their antibodies) to be held and retained inside a column, by layers of semi-permeable screen at both ends of the column, while a liquid is being pumped through the column.

The term “semi-permeable” indicates that the inlet and outlet screens (which also can be called a mesh, net, filter, or similar terms) are permeable to the liquid and to the particulates in the liquid, but they are not permeable to the beads or other sorbent material, and therefore can be used to retain the sorbent material inside the column. It should also be noted that in some cases, liquid preparations must be filtered, centrifuged, or other wise “clarified” before they can be passed through a chromatography column.

In a typical chromatographic process, a liquid containing the target proteins in dilute or impure form (such as, for example, an aqueous solution containing cells and a secreted protein, or a solution created by using a homogenizer, ultrasonic sound, or other processing to break apart cells containing a non-secreted protein) is passed through the column containing the antibodies that will bind to the desired protein. Any water-soluble proteins and other molecules will pass through the column fairly rapidly, since they will not become bound to the antibodies that are affixed to the beads. However, the targeted proteins will bind to the antibodies, and will be retained inside the sorbent column.

The bulk of the liquid, which passes rapidly through the column, is discarded, or processed in any other desired manner. When the bulk liquid has finished passing through the column, the conditions of the column are changed in a way that causes the antibodies to release the targeted proteins. This is commonly done by increasing the salinity and/or acidity of the liquid being passed through the column, and the temperature of the column may also be increased. Once the targeted proteins have been released by the antibodies, they will emerge from the column, and they can be collected, in concentrated form, in specific “fractions” of liquid. Ideally, the target proteins should emerge in a sharp and distinct “peak” (which can also be referred to as a spike, limited to only a few specific fractions, as can be determined by various analytical techniques. The fractions containing the purified proteins are isolated, and utilized in any way desired (for example, the carrier liquid can be evaporated, removed by ultrafiltration, etc., to create an even more concentrated protein preparation).

The foregoing description is merely a brief illustration of an exemplary process, and is not limiting. Numerous variations and other types of chromatographic purification are known to those skilled in the art, and are described in numerous texts, review articles, sales brochures, and websites. In particular, it should be noted that numerous types of non-antibody sorbents (frequently referred to as “resins”) have been developed, for “ion exchange” and other types of chromatography, and chromatography is often used to purify non-protein molecules, including drugs, specialized nutrients, etc. Similarly, columns that contain strands of DNA or RNA with specific known sequences, affixed to beads, are sometimes used to purify DNA or RNA fragments having complementary binding sequences.

As used herein, terms such as purification, purified, etc. are used broadly, and include any form of chromatographic processing that increases the concentration and/or purity of a desired compound in a carrier liquid, regardless of how closely the desired compound approaches a level of 100% purity. For example, if a chromatographic process increases the purity level of a certain protein from 3% to 30%, that would be regarded as a form of purification, and the resulting mixture would contain a purified protein.

When antibodies are involved, this type of chromatography uses a process called “affinity binding”. That term refers to binding reactions that can be used in practical and reversible ways because they involve “non-covalent” attraction and binding between different atoms and molecules. The requirement that affinity binding must be reversible means that two bound compounds must be detachable, using practical means and under conditions that can be created in a column, without irreversibly altering the molecules involved in the binding reaction. The binding of an antibody to an antigen, the binding of an enzyme to a substrate molecule, and the binding of a cell receptor to a “ligand”, offer classic but non-limiting examples of affinity binding.

Affinity binding is one subclass of a larger class of reactions known as “adsorption”. That term refers to the tendency of certain components in a liquid to adhere to some type of surface or compound that remains relatively stationary. For example, the passage of a certain type of mixture through an ion exchange or other resin, or along the length of a sheet of filter paper or similar permeable material, in a way that causes or allows one or more components of the mixture to bind to the material that is being traversed with differing degrees of affinity, enables mixtures to be purified in ways that can be called chromatography, adsorption chromatography, or similar terms.

Extensive information is available on chromatography, adsorption, and affinity binding in numerous textbooks and review articles, and those terms are used herein in the manner conventionally used by biochemists. Accordingly, references herein to “chromatography” are used for convenience, to refer to purification methods that use differential adsorption, affinity binding, or similar processes that are referred to by skilled biochemists as various forms of chromatography.

It also should be recognized that chromatography is divided into two broad but overlapping categories, referred to as analytical chromatography, and preparative chromatography. In general, analytical chromatography uses smaller volumes, and is done under laboratory conditions to help researchers study targeted molecules, and to help engineers and others design, build, and optimize commercial-scale systems. Accordingly, analytical chromatography often involves close and careful attention to the columns and processes, by researchers. By contrast, preparative chromatography usually involves larger volumes, and is used in the commercial-scale manufacture of products that will be sold or otherwise used. Therefore, it is more sensitive to the need for efficient and reliable processing that can avoid chronic or sporadic problems (often referred to as “upsets”), without requiring close or constant supervision of each and every column. Accordingly, the improved devices and methods disclosed herein will have their greatest utility and value in preparative chromatography; however, these improved devices and methods can also be useful in analytical chromatography as well. In addition, as noted above, there is substantial overlap between analytical and preparative chromatography (as examples, if small quantities of a drug are being purified for testing in limited animal or clinical trials, or for sale to research institutions, that processing might be regarded as either analytical or preparative).

In the late 1980's and 1990's, a new approach to chromatography was developed, referred to as “expanded bed” chromatography. The two companies that pioneered this effort were Amersham Biosciences (later purchased by Pharmacia, then by General Electric Healthcare), and Upfront Chromatography (www.upfront-dk.com). Extensive information (including illustrations) on their products and processes is provided on their websites. Various types of columns and accompanying devices and reagents for carrying out expanded bed chromatography are sold by G.E. Healthcare (which reportedly has also licensed some of the more important developments created by Upfront Chromatography), under the STREAMLINE trademark. The drawings provided in FIGS. 1 and 2, which are prior art, are simplified depictions of two types of STREAMLINE columns that are already commercially available. Those figures are described below, in the summary of expanded bed chromatography prior to this current invention.

One of the main problems addressed by expanded bed chromatography is that many liquids that contain valuable target molecules also contain heavy loads of particulates. Such particulates mainly include intact cells, debris that is created when cells are broken apart by steps such as detergent treatments, sonication, or passing the cells through a homogenizer, and precipitated or agglomerated nutrients that were used during cell culturing and fermentation. Such particulates can clog up the screens that are used to hold beads, resins, or other sorbent materials in a column while liquids pass through the column; they can also cause other problems, such as forming clumps inside a column.

Expanded bed chromatography provided a useful advance in processing liquids that contain particulates, by effectively allowing two different processing steps to be combined and/or carried out sequentially, in a single column. The two conventional steps are: (1) initial processing of crude liquids that contain large concentrations of particulates, such as cell debris, in a way that removes most of the debris from the “clarified” liquid, while leaving most of the targeted and valuable molecules in the liquid so they can be purified; and, (2) first-stage chromatography of a clarified liquid, using reagents such as monoclonal antibodies, ion exchange resins, etc., to achieve a large gain in purity.

As initially developed, expanded bed chromatography allowed those steps to be combined by using a modified column. A typical operation can be regarded as comprising 5 major steps, as follows:

1. The first step involves set-up, preparation, and equilibration of a column. The selected sorbent material is loaded into the column, in a suitable liquid. If beads are used, they normally are made of a “substrate” material that is denser than any liquids that will be used; this allows the beads to settle into a “packed” bed, at the bottom of a column, when liquid is not flowing upward through the column. The beads can be coated (or in some cases impregnated) with ion exchange compounds, antibodies or other proteins, or other agents that will selectively bind to the molecules being purified.

As depicted in FIG. 1, which is prior art that provides a simplified cross-sectional view of a STREAMLINE™ system as sold by G.E. Healthcare, column 50 comprises a barrel or sleeve 52, which contains beads 54. Beads 54 are trapped and held inside column 50 by a lower screen (or mesh, net, filter, etc.) 56, and an upper screen 62. Lower screen 56 is positioned above a flow-distributor plate 58, which is used to reduce the problem of “channeling”, discussed below. Upper screen 62 is affixed inside a piston 60 that can move up or down, surrounded by a rubberized O-ring 68 to provides a watertight seal in barrel 52. Upper screen 62 is also positioned below a flow-distributor plate 64.

The lower screen 56 and upper screen 62 are semi-permeable, and have pore sizes that prevent beads 54 from passing through either screen. For example, many screens used to process liquids containing plant, mammalian, or yeast cells have pore sizes of about 20 microns, which is about twice the diameter of plant, mammalian, or yeast cells. This allows cells and cell debris to pass through the screens; however, the smallest sorbent beads used with these types of screens usually have diameters of about 50 microns. This prevents the beads from passing through the screens, and it minimizes the number of beads that become wedged and jammed into the pores of a screen.

(2) The second step is called “loading” of the column, but this does not refer to leading the sorbent beads into the column. Instead, this step refers to loading up the valuable targeted molecules onto the surfaces of the beads, by passing the liquid carrying the valuable molecules, through the column of beads. During the loading stage, the liquid carrying the cells or debris and the valuable target molecules moves upward, at a rate and velocity that breaks apart the settled mass of beads. This effectively creates a “fluidized” bed. By breaking up the settled mass of beads and causing the beads to float within a moving liquid, a fluidized bed allows much easier passage of particulates through the bed and out of the column, in a way that prevents clogging of the column. At the same time, because of the tiny size and huge number of the beads, and the aggregate mass and height of the fluidized column (which often is longer than a meter, in preparative chromatography), the relatively slow upward flow of the liquid, through the fluidized bead, allows and promotes binding of the target molecules to the sorbent beads.

(3) The third step is referred to as “washing” of the column. This uses a washing liquid, which typically is a relatively inexpensive salt-containing buffer that is solubilized and contains no particles of any sort. Passage of this inexpensive liquid through the bed will ensure that essentially all of the particulates are washed out of the bed, and removed from the column. However, this washing step will not cause the valuable target molecules to be released by the beads.

(4) The fourth step is called “elution” of the column. It uses a clear liquid, usually with a higher level of acidity and/or salinity than the washing liquid (higher temperatures are sometimes used, especially in smaller columns, and competitive binding reagents are also used in some processes). The higher levels of acidity, salinity, etc. cause the target molecules to be released from the sorbent beads. Using continued flow of the elution buffer, the released target molecules are removed from the column in liquid “fractions” that are collected for additional processing.

(5) The fifth and final step includes cleaning, regeneration, or other handling of the column, so it can be used again. It has no effect on the target molecules or the cell debris, which have been removed from the column by the time this final stage is reached.

In the initial form of expanded bed chromatography, upward flow and “fluidized bed” conditions are essential, during both the loading step (step 2) and the washing step (step 3). However, before step 4 is carried out, the column is returned to “packed bed” conditions. For various reasons, the use of “packed bed” processing, during the elution step, will allow the target molecules to be collected in a more concentrated and purified form than can be achieved by elution under fluidized bed conditions. This factor can be visually depicted, on a graph that displays the quantity or concentration of valuable molecules in successive fractions of elution buffer that emerge from the column, by taller, more narrow, and sharper “peaks” that can be obtained from packed beds compared to fluidized beds.

Accordingly, in a preferred and ideal form of expanded bed processing (which can indeed be used, in many situations in which the particulate load is not heavy), fluidized bed processing is used during the loading and washing stages. After those stages have been completed, the flow is stopped, the fluidized beads are allowed to settle, and packed bed processing is used during the elution stage.

To provide even better results, researchers have developed a number of enhancements for expanded bed processing. As one example, expanded bed chromatography sometimes uses beads having a range of different sizes and/or densities, to allow the beads to establish two or more layers, or zones, within a column. The use of different zones, in a single column, can help make the separation process more efficient. Similarly, beads have been created from hard minerals (such as zirconia) that have higher densities than agarose or polymer beads. This can allow certain types of improved handling, and it can also allow some hard-mineral beads to be regenerated in ways that cannot be achieved with soft beads.

Detailed summaries of expanded bed chromatography are provided in articles that can be downloaded from various websites, such as an excellent introductory article by Randall Willis, assistant editor at Modern Drug Discovery, posted at the American Chemical Society website, at http://pubs.acs.org/subscribe/journals/mdd/v04/i12/html/12toolbox.html. Patents that describe expanded bed chromatography include, for example, U.S. Pat. No. 5,759,395 (Hagerlid 1998, assigned to Pharmacia Biotech, of Sweden, and U.S. Pat. No. 6,620,326 (Lihme et al 2003, assigned to Upfront Chromatography, of Denmark). Extensive information (including illustrations) is also provided on the websites of G.E. Healthcare and Upfront Chromatography.

Despite the advances that have been made in expanded bed chromatography over the past 10 years, several important problems still remain, and those problems limit or impede (and in some cases prohibit) the processing and purification of various liquids and molecules, using true expanded bed methods and equipment. Depending on the liquids being processed and the reagents and equipment being used, those types of problems can include any or all of the following:

1. The particulates of the feedstock can clump together at the inlet screen or the flow-distributor plate. This often forms a barrier that is usually called a cake, but which often has a consistency and viscosity similar to guacamole dip. The formation of a cake, on an inlet screen or flow-distributor plate, will then block and impede the desired flow patterns during the rest of the processing.

The desired liquid flow through a chromatography column is often referred to as “plug flow”. This implies that ideally, each successive liquid (i.e., the loading liquid, the washing liquid, and the eluting liquid) should move through the column in a manner that maintains horizontal boundaries between the liquids, as each liquid carries out its desired function and is then displaced by the subsequent liquid. If “plug flow” is disrupted, such as by clogging of an inlet screen or distributor plate at one or more areas, subsequent flow through the plate, screen, and column can generate channels (also called tunnels, breakthroughs, etc.). Within the channels, flow velocities are too high, and in non-channel regions, flow velocities are too low. These uneven flow rates lead to stagnant zones, uneven processing, and impaired purification.

2. If a cake begins to form on the bottom surface of an inlet screen, pieces of debris that begin to accumulate on the screen will effectively reduce the pore size of the screen. This can causing even more particulates to accumulate on the screen, in a “vicious circle” type of cascading effect. This can lead to rapid increases in back-pressure, and it often renders a column unusable from that point on, requiring the process to be shut down so that the mesh can be cleaned. Typically, this requires complete cleaning and regeneration of the bead preparation, in the column.

3. In addition, if a cake forms on the bottom surface of an inlet plate or screen during the loading stage, the cake is likely to remain intact throughout the loading and washing steps, since the liquid will simply choose routes with less resistance, and will move around the outside of the cake. Subsequently, during elution, if the flow is reversed and sent through a column in a downward direction, the downward flow will often break apart the cake. This will cause the cake to suddenly begin releasing large quantities of cell debris and other contaminants, into the product pool. This is highly adverse, and it can seriously reduce the utility of the process.

4. Within the column, lumps or aggregates are often formed when multiple beads become stuck together, by cells and other sticky components of the feedstock. Sorbent beads that are trapped within the interior of those types of aggregates cannot participate fully in binding or elution reactions. If this happens, the binding capacity of the column is reduced, and purification is impaired.

In addition, it should be recognized that on a practical level, elution and collection of valuable target molecules, using upward flow of an elution liquid, is difficult and problematic, even though it may be desirable in some cases. Although it theoretically may be possible to carry out “plug flow” elution through a packed bed using upward elution flow, in actual practice, it is common for upward flow of the elution liquid to break apart the packing of the bed, causing the packed bed to become fully or partly fluidized. If this occurs, fractions that contain the target molecules will usually occupy a substantially larger volume than could be achieved using packed bed conditions. This leads to increased costs during any subsequent storage, processing, and purification.

As the results of efforts to overcome or at least limit those types of problems, two different classes of designs have emerged, for expanded bed columns.

One such design uses a movable piston, positioned at the top of the column, as illustrated by piston 60 as shown in FIG. 1. During the first three stages of processing (i.e., during the setup and equilibration stage, the loading stage, and the washing stage, as described above), the piston is moved to a raised position, to allow extra space (often called “headroom”) for expansion of the beads into a fluidized bed.

Subsequently, when the elution stage is ready to begin, the upward liquid flow is stopped, the beads are allowed to settle into a packed bed, and the piston is lowered until it is relatively close to the upper surface of the packed bed. This reduces the “headspace” (filled by relatively clear liquid) above the packed bed beneath the exit screen 62 on the lower surface of the piston 60. Therefore, the use of a movable piston can help provide a sharper elution peak, so that the product can be recovered in more concentrated form.

However, this system suffers from certain shortcomings, which include:

1. The use of a piston at the top of a column does nothing to prevent or reduce the formation of a particulate cake, on the bottom distributor plate and/or inlet screen. As a result, all of the cake-related problems mentioned above will continue to apply.

2. The “sliding piston” design is somewhat complex and expensive, and is subject to a risk of jamming, breakage, or other mechanical problems (especially since “dirty” liquids are usually being processed), as compared to fixed-end column designs.

3. While relatively small column tubes with good precision can be made from glass, large-diameter barrels of the type that used in commercial-scale processing usually require acrylic or stainless steel walls, to accommodate the pressures that are used. However, acrylic tubes are not well-suited for intermittent sliding of a piston in the presence of sorbent beads (which can be very abrasive, especially if made from minerals such as zirconia, for greater density). Stainless steel is more capable of withstanding abrasion, but it is not transparent, so precise lowering of a piston onto a sorbent bed, at the start of an elution stage, becomes difficult, especially when it is difficult to predict the exact level where the bed will settle and compact itself to, at the end of an elution step, after the beads have become partially loaded with target molecules and with debris.

4. The exit screen, on the lower surface of the piston, frequently becomes somewhat clogged during the loading step. As a result, users often remove the exit screen from the bottom of the piston, before the elution stage begins. However, without the mesh, the piston cannot be lowered directly onto the sorbent bed, since the mesh also serves as a baffle and distributor, during elution. Even and uniform distribution of the elution liquid, across the upper width of the column, can be seriously compromised if the exit screen is removed.

5. If a column having this design is operated without a piston, the elution step often renders a diluted product, regardless whether elution flow is in a downward or upward flow direction.

Various efforts have been made to avoid the problems that arise when piston systems are used, by using approaches such as, for example, creating sharp density gradients between two different elution liquids (e.g., U.S. Pat. No. 6,027,650, Van Reis et al 2000, assigned to Genentech). However, those approaches require additional operating delays, expenses, and other burdens, and are not entirely satisfactory. In addition, those systems still suffer from other problems and limitations, as described above.

It should be recognized that, while expanded bed processing is quite useful for many liquids that do not contain high particulate loads (or that contain no particulate load at all), it is not practical and effective for processing other types of liquids that contain high particulate loads. As a result, true “expanded bed” processing simply cannot be used for processing many of the types of liquids that could benefit most from such processing.

As a result, a “rotating distributor” design was developed which does not use an inlet screen or distributor plate at all. This type of system is described in publications such as U.S. Pat. No. 6,620,326 (Lihme et al 2003, assigned to Upfront Chromatography, of Denmark). Briefly, this type of rotating distributor design uses a fluidized bed during all stages of loading, washing, and eluting; therefore, it does not enable true “expanded bed” processing of the type that uses loading and washing of a fluidized bed, followed by elution of a packed bed.

A “rotating distributor” column attempts to provide evenly-distributed upward flow of liquid, through a sorbent bed, by passing the particulate-containing liquid through a rotating or oscillating distributor device that has two or more arms that extend outwardly (radially) from a center axis. This system has no bottom mesh; instead, the feedstock liquid (as well as the washing liquid, and the elution liquid) all exit from the moving arms of the distributor, through holes that point downward, in a manner similar to an inverted lawn sprinkler. The liquid passes through beads suspended in a liquid, in a fluidized bed, and it exits from the column via an outlet at the top of the column.

Since this type of column has no lower mesh, it avoids an entire set of clogging, caking, and channeling problems, when processing liquids containing heavy particulate loads. However, this type of column can be operated only in an upward flow mode, and the sorbent bed remains fluidized, during elution.

The shortcomings of this design include the following:

1. The presence of internal moving parts that must interact with abrasive sorbent particles within the column results in a fast wear of various components, greater problems with leakage, etc.

2. It is difficult to disassemble the column for cleaning and sanitation.

3. The requirement of fluidized bed conditions during elution renders this system unable to achieve the levels of concentration and purity that can be achieved by elution of packed beds. As a result, the product is more diluted, and the diluted output requires greater downstream processing and expenses.

4. This design also tends to require heavier and more dense material for the beads, which can increase their expense and make certain types of otherwise desirable substrate materials unavailable for use in this type of column.

It should also be noted that various additional designs and enhancements have been tested and used for expanded bed chromatography. As one example, various types of columns have been developed that use side-mounted inlet and outlet ports, with an inlet port positioned above the lower mesh, to avoid problems of mesh clogging, and an outlet port mounted below the mesh. However, those designs suffered from other problems and performance shortcomings, and they are not being actively sold by either of the major vendors in this field.

Accordingly, one object of this invention is to disclose an improved piping and fluid-handling design that helps promote and ensure uniform (or nearly uniform) plug-type flow through a column, during a purification process that uses affinity binding (such as expanded bed chromatography).

Another object of this invention is to disclose a simple, cost-effective device for use in expanded bed chromatography or other affinity binding purification, to prevent or reduce the formation and growth of cakes or clogging on the inlet device(s) that support the sorbent material in a column.

Another object of this invention is to disclose a simple, cost-effective device and method for use in expanded bed chromatography or other affinity purification, which can optimize the flow system in ways that can stabilize and protect the column during all processing steps, and that can sharpen the peak and reduce the volume of eluant that contains the targeted product.

Another object of this invention is to disclose a device and method for use in expanded bed chromatography or other affinity purification, which can eliminate the need for a piston, rotating distributor, or other device that requires moving parts to be placed inside a column where the moving parts would have to interact with potentially abrasive sorbent materials.

### SUMMARY OF THE INVENTION

Devices and methods are disclosed herein for expanded bed adsorption and/or chromatography, which can: (i) reduce or in some cases eliminate the need for pistons, rotating distributor arms, or other moving parts that will directly contact sorbent material in a column; (ii) reduce the risk of clogging, fouling, and cake formation on an inlet flow-distributor plate and/or inlet screen that supports the sorbent material; and, (iii) allow efficient elution of a packed (rather than fluidized) bed. This system can handle a wider range of liquids, having heavier particulate loads, than can be handled today using expanded bed chromatography.

One enhancement provides both an inlet port and an outlet port, positioned near the bottom of the column, beneath any distributor plate and/or inlet screen or mesh that the sorbent material rests upon. The use of both an inlet port and an outlet port, in the bottom region of a column, can establish a horizontal form of tangential or “sweeping” flow that will sweep across the lower surface of a distributor plate of inlet screen, reducing the risks and rates of formation of particulate cakes and the problems that arise from such cakes. This tangent-flow (or sweep-flow) system has been tested in prototype columns, and it is surprisingly effective in preventing and suppressing clogging and cake formation, even when used to process liquids that contain heavy loads of particulates.

Another enhancement involves the use of pulsatile flow, and/or a vibrating or intermittent hammering or knocking mechanism that can disrupt and reduce the formation of cakes, lumps, or other aggregates. When used in combination with a sweep-flow system, these enhancements can substantially extend the range of liquids that can be purified in a practical and efficient manner, using a screen or mesh to enable elution of a true packed bed, after loading and washing have been completed. Packed bed elution is more efficient than fluidized bed elution, and can provide product outputs that are more concentrated and purified.

### BRIEF DESCRIPTION OF THE DRAWINGS

FIG. 1 is prior art, and is a cross-sectional depiction of a STREAMLINE™ column as sold by G.E. Healthcare, showing a single inlet port at the bottom of a column that contains sorbent beads above an inlet screen. FIG. 1 also shows a piston at the top of the column, which can be lowered before elution begins, to sustain packed bed conditions during upward-flow elution.

FIG. 2 is a cross-sectional elevation view that depicts a tangential or “sweep” flow system of the current invention, using an inlet port and an outlet port near the bottom of the column to establish horizontal flow of a liquid through a fluid flow compartment, located beneath a lower distributor plate and/or inlet screen that supports a sorbent material. Tangential fluid flow across the distributor plate and/or inlet screen, which can be controlled by adjusting flow rates through both the inlet and the outlet ports, reduces and minimizes cake formation during the loading and washing stages of a purification process.

FIG. 3 depicts an arrangement that uses (i) a vibrator, tapping device, or other mechanism to disrupt clogging and cake formation on the bottom of distributor plate and screen, (ii) a hollow tube that can be used to intermittently blow out aggregates that are beginning to cause clogging or cake formation, and (iii) inlet or outlet ports on the side of the column.

### DETAILED DESCRIPTION

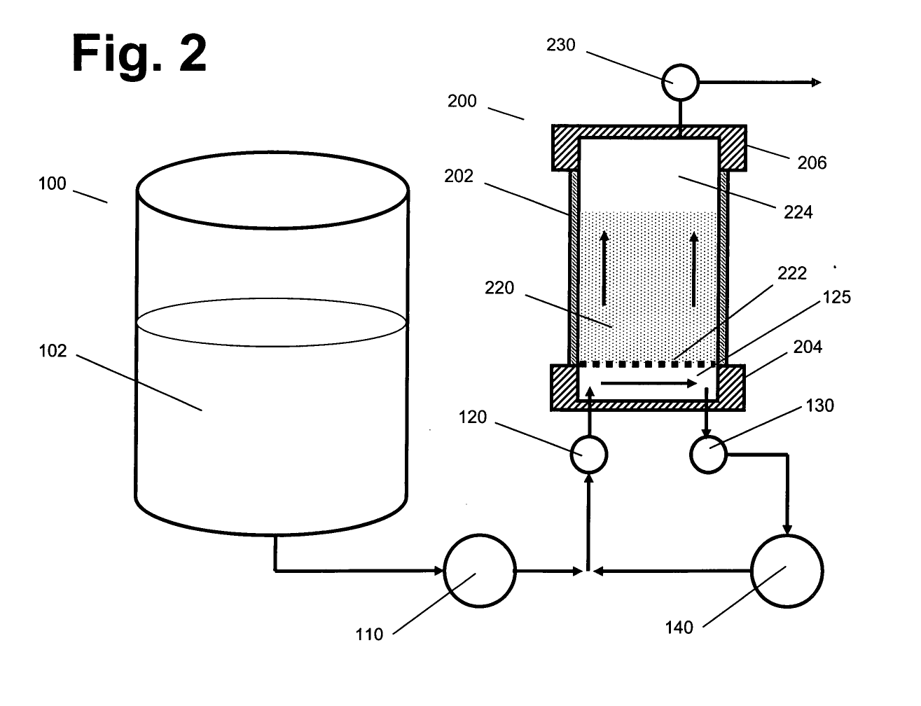

A tangential or “sweep” flow system as summarized above is illustrated in FIG. 2, which provides a cutaway view of a chromatography column 200. Column 200 is being used to process a liquid 102, which is held in tank or vessel 100. Liquid 102 contains both a suspension of particulates (such as cells or cell debris), as well as some concentration of a valuable “target molecule” that is to be purified. With the aid of pump 110, liquid 102 is pumped through an inlet port 120, into a fluid flow compartment 125 positioned at the bottom of column 200.

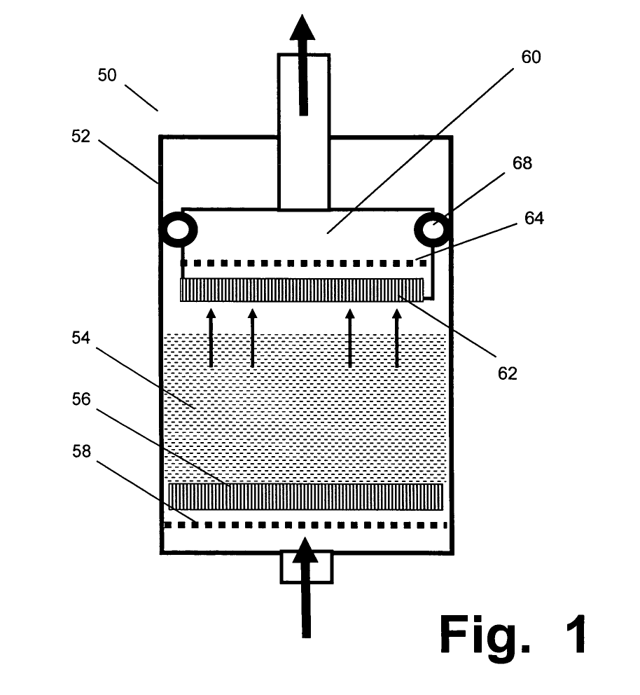

Column 202 has at least one impermeable wall 202, a lower cap 204, an upper cap 206, and an upper outlet port 230. It can also be provided with a movable piston near the top (such as shown by piston 60, in FIG. 1) and/or any other accessory, appurtenance, or enhancement that is already known or hereafter discovered or developed.

Inlet port 120 preferably should be provided with a shut-off valve, for convenience. If pump 110 is a peristaltic pump, its flow rate can be easily adjusted, by adjusting the speed of the pump. Alternately, if pump 110 does not provide adequately sensitive control of the inlet flow rate, an adjustable valve can be provided as part of (or coupled to) inlet port 120.

A fluid flow compartment 125 is contained generally within lower cap 204, with its upper surface determined by semi-permeable support component 222, which preferably should comprise a fluid-flow distributor plate with an inlet screen positioned above it. Sorbent beads, resin, or other material 220 rests on the top surface of the support component 222. Support component 222 has a mesh or pore size that enables liquid 102 and any particulates suspended therein to pass through it, while the sorbent beads or other material is/are too large to pass through the support component 222.

As liquid 102 passes through fluid flow compartment 125, a portion of the liquid 102 (with its entrained particles) passes upward, through the semi-permeable support component 222 and then through sorbent material 220. The remaining portion of liquid 102 passes in a direction that is referred to herein as “tangential” to semi-permeable support component semi-permeable support component 222 (this direction of flow can also be referred to as “sweeping” across the support component 222. This type of tangential flow is promoted and increased by the fact that a portion of the liquid is being removed from fluid flow compartment 125 via an outlet port 130, which preferably should be provided with a shutoff valve, for convenience. A peristaltic or other adjustable pump 140 is also coupled to outlet port 140. Pump 140 (in combination with any valve that may be provided as part of outlet port 130) should be adjustable.

By adjusting the flow rates that are passing through both inlet port 120 and outlet port 130, the total flow that is passing through inlet port 120 can be divided in a controllable manner between: (i) upward flow, through sorbent material 220, and (ii) tangential flow across the surface of semi-permeable support component 222. The desired ratio and speeds of those two flow components will vary, depending on the particular type and characteristics of a liquid that is being processed in a specific operation. For example, if a liquid has a heavy particulate load, a higher tangential flow rate (created by a relatively higher flow rate through outlet port 130) can help prevent cake formation on the bottom surface of support component 222. By contrast, a liquid with a low particulate load can be passed mainly through the sorbent material, with only a small portion providing tangential (sweep) flow across support component 222 and exiting via outlet port 130.

Even though the velocity of the horizontal flow will not be great, tests using prototype columns indicate that even a fairly minor tangential flow of liquid across the lower surface of the support component 222 can, in at least some liquids, make a very substantial difference in the quantity and rate of cake formation on the lower surface of the support 222.

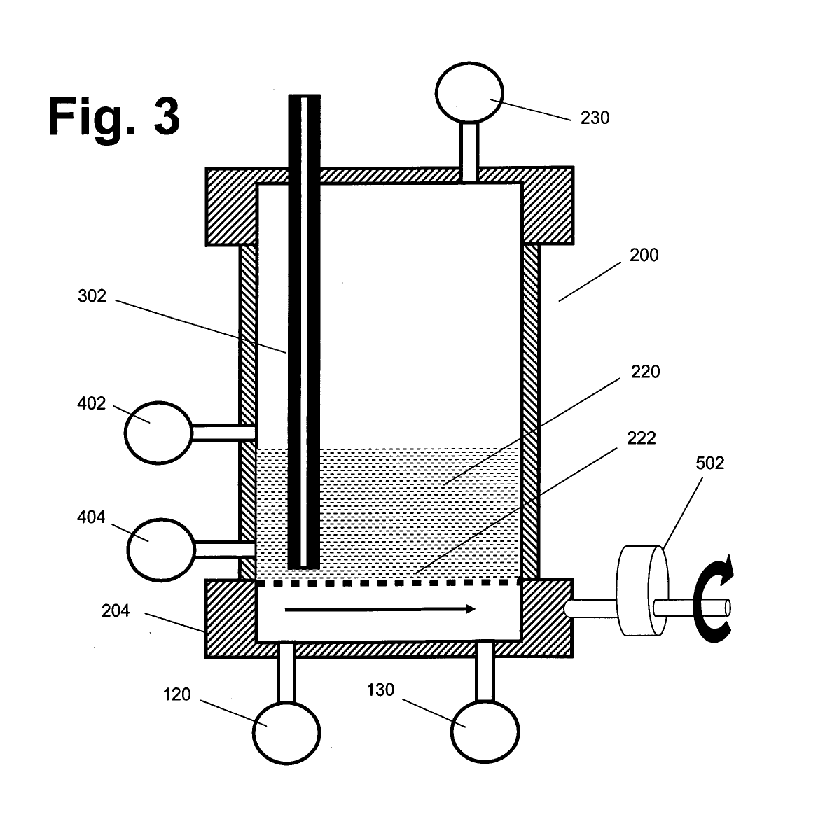

In addition, cake formation on the bottom of support 125 can be reduced even more by a mechanical disrupter that vibrates, jostles, taps, or otherwise moves support component 125. Examples of these types of mechanical “disruptors” include, for example: (1) affixing a vibrator 502 (as shown in FIG. 3) to column barrel 202 or lower cap 204; or, (2) using a hammering or knocking device to periodically or intermittently rap on one or more sides of the column barrel 202 or lower cap 204. If this type of mechanism is used, the column can be mounted on top of vibration-damping supports (such as rubber pads), to reduce noise levels as well as transmission of vibration energy to the floor or to other equipment.

In addition, after seeing the effectiveness of external mechanical disruptors (combined with horizontal sweeping flow in the sub-mesh zone) in preliminary tests, it is also believed that it may be feasible and effective to emplace a vibrating device or other aggregation-disrupter inside the vessel itself. For example, a corded or battery-powered device, which can be lowered into the column 200 during a loading and washing step, or which can be affixed in a removable manner to an inside wall of barrel 202, can be used to continuously or intermittently vibrate within the fluidized bed material, or to periodically rap on the top surface of the support 222. When used in combination with tangential sweep flow in the fluid flow compartment 125, at least some types of aggregation disrupters are likely to be effective in preventing caking and clogging, with minimal disruption of plug flow.

Similarly, combinations of the various approaches mentioned above can be used. For example, an internally-mounted device that intermittently raps on the top of mesh layer 222 can be used in addition to a vibrator mounted on the outside wall of barrel 202 or the lower end cap 204.

Similarly, alterations in the flow patterns beneath support component 222 may be helpful in reducing caking and clogging. For example, the flow direction in the flow compartment 125 can be intermittently reversed, if desired, in a way that would carry the liquid in a left-to-right direction.

Alternately or additionally, the flow direction through inlet port 130 can be briefly reversed, such as for a duration of only a few seconds. In at least some types of liquids, this brief reversal of flow through the mesh layer 222 could rapidly dislodge and “blow out” any caking deposits that have begun to form on the bottom surface of the mesh 222, returning those particles into the liquid that fills the sub-mesh zone 250, without disrupting the loading process that enables valuable molecules to become affixed to the sorbent material in a fluidized bed. When this type of “brief reverse flow” technique was tested on systems that did not use a tangential sweep flow across the surface of the supporting screen, it apparently provided little or no benefit, since the particles that were slightly dislodged from the mesh apparently just returned to the mesh as soon as upward flow resumed. However, because the pores of the mesh are very small (typically measured in microns), even a slight horizontal displacement, as would be caused by tangential sweep flow within a second or two, would likely displace the dislodged particle horizontally, a sufficient distance to prevent them from returning to the same place in the mesh. Therefore, this technique merits testing and evaluation for use in combination with the systems disclosed herein.

It also should be noted that it may be possible and practical to introduce vibrational or even hammering-type energy into the system, at levels that may be able to disrupt the formation of cakes and aggregates without disrupting the binding of the valuable molecules to the sorbent materials, directly through one or more liquid streams or channels. This would be comparable to transmitting sound waves through water or other liquids, using a speaker-type or other vibrating, pulsating, or hammered device to send mild shock waves through the liquid in the column, during a loading, washing, or eluting step.

It should also be noted that these types of mechanical disruptors, if used in a properly timed manner, may also be able to promote accelerated release of adsorbed molecules from the sorbent material, during elution. In at least some types of liquids and processing reactions, if the elution-stage release of valuable molecules from sorbent materials is suddenly accelerated, by means of a mechanical shock wave or similar disruption that is sent through the liquid, it may promote intensified and concentrated elution peaks, leading to better recoveries and lower total costs.

The devices, mechanisms, and approaches disclosed herein can also be adapted for use with any other techniques that have been shown to be successful in one or more types of expanded bed chromatography. As just one example, in some types of processes, a layer of a dense liquid, such as glycerol, is introduced into a column (usually by mixing it with a liquid buffer) at one or more stages during the process, to try to create a more uniform type of horizontal plug flow through the column, to create a travelling fluid interface that is sometimes referred to as a “liquid piston”. Any such tricks, techniques, or other steps that are already known or hereafter discovered can be tested, to evaluate their efficacy when used in combination with the devices and methods disclosed herein, in processing any particular liquid mixture using any particular type of sorbent material.

FIG. 3 also illustrates alternate piping, tubing, porting, and plumbing systems that can be tested and used, if desired, with any particular type of liquid or sorbent material. For example, FIG. 3 depicts a tube 302 that extends down into the sorbent material 220. The height (i.e., the depth of insertion) of these types of tubes can be adjusted, during a procedure. This allows them to be used, for example, to rapidly unpack sorbent material, and/or to rinse out the “headspace” above a settled and packed bed. Accordingly, this type of hollow tube might be used in the current invention, as a port having an adjustable height.

Alternately, if desired, a mechanical system can be designed and provided, to cause the lower end of tube 302 to move slowly around and across the surface of the support component 222, while a slow stream or intermittent jets of a buffer liquid or other suitable fluid are passed through the tube. In at least some uses, this could provide an effective means for dislodging any particulates that are beginning to form a cake layer, on the bottom surface of the mesh 222. As one example of a mechanical system that could allow travel of the lower end of a hollow tube 302 across the upper surface of the mesh 222 without requiring a major alteration to the column 200, the shaft of hollow tube 302 could pass through a spherical grommet that would pass through upper end cap 206, presumably near the middle of the end cap. The grommet can be made of a hard rubber or plastic material, secured within an accommodating fitting that would maintain a water-tight, pressure-tight seal. The tube 302 could be moved like a lever, using the grommet as a fulcrum, allowing its lower end to travel around the surface of the mesh layer 202 as a stream or intermittent jets of fluid are expelled from its tip, to dislodge caking deposits from mesh 222.

Alternately or additionally, one or more ports (such as ports 402 and 404, shown in FIG. 3) can pass through the wall of barrel 202, at any desired height(s) that may be useful during a particular type of purification process.

Accordingly, these and other plumbing options are available, and can be built into any particular system designed to handle a specific and known combination of a liquid that needs to be processed, and a sorbent material that will be used to purify some particular molecule from that liquid.

Those who are familiar with expanded bed chromatography will readily recognize the various operating steps that will need to be used to carry out the equilibration, loading, washing, eluting, and cleanup steps, in any particular system that is being constructed or assembled. In particular, any company that sells such equipment will have a team of technical specialists who will recognize and understand any and all necessary operating procedures, and who can prepare illustrated instructions, training presentations or videos, and even software code that can be loaded into the memory devices of computers, programmable logic devices, or other automated control systems that can be used to run a particular column.

Thus, there has been shown and described new and useful devices and methods for designing and operating chromatography systems more efficiently than could be accomplished under the prior art, and with a wider range of liquids that contain particulate loads. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A method of processing a liquid containing a mixture of desired target molecules and undesired particulates, comprising pumping said liquid into a column device containing a sorbent material that is retained within said column by a semi-permeable support component that is permeable to the liquid and undesired particulates but impermeable to the sorbent material, wherein the liquid containing the target molecules and particulates is pumped into a fluid flow compartment that is provided with an inlet and an outlet, wherein flow rates through each of said inlet and outlet can be adjusted in a manner that can establish fluid flow through said fluid flow compartment in a direction tangential to the semi-permeable support component.

2. The method of claim 1 wherein the sorbent material uses affinity binding to retain the desired target molecules in the column device until an elution stage is performed.

3. A device for processing a liquid containing a mixture of desired target molecules and undesired particulates, comprising:
a. a processing chamber having at least one impermeable wall and having a first end with at least one inlet and at least one outlet, and having a second opposed end with at least one outlet; and,
b. means for securing a semi-permeable support component at or near said first end of said processing chamber, thereby establishing a fluid flow compartment on a first side of said semi-permeable support component and a sorbent-holding compartment on an opposed second side of said semi-permeable support component,
wherein at least one inlet and at least one outlet at said first end of said nonpermeable processing chamber are designed to establish fluid flow that will cause a portion of said liquid to pass through said semi-permeable support component while flowing in a direction that is tangential to said semi-permeable support component.

4. The device of claim 3 which is also provided with a mechanism for mechanically disrupting particulate aggregation on said semi-permeable support component.
